(19) United States
(12) Patent Application Publication
(10) Pub. No.: US 2025/0139957 A1
(43) Pub. Date: May 1, 2025

(54) IMAGE COMPRESSION USING OVER-FITTING AND TEXT-TO-IMAGE MODEL

(71) Applicant: International Business Machines Corporation, Armonk, NY (US)

(72) Inventors: Zhong Fang Yuan, Xi'an (CN); Tong Liu, Xi'an (CN); Yi Ming Wang, Xi'an (CN); Yu Zui You, Ningbo (CN); Yan Fen Liu, TianJin (CN)

(21) Appl. No.: 18/385,548

(22) Filed: Oct. 31, 2023

(51) Int. Cl. G06V 10/82; G06F 16/22; G06F 40/20

(52) U.S. Cl. CPC G06V 10/82; G06F 16/2246; G06F 40/20

(57) ABSTRACT

Train a text-to-image machine learning model by using a training dataset. The training dataset includes images and respective natural language descriptions of those images. The training causes the text-to-image machine learning model to be overfit on the training dataset. Store the trained overfit text-to-image machine learning model. Submit a given natural language description to the stored overfit text-to-image machine learning model. In response to the submitting, receive as output from the overfit text-to-image learning machine learning model an output image. The output image is a reproduction of a corresponding image from the training dataset and corresponds to the submitted natural language description.

### BACKGROUND

The present invention relates generally to the electrical, electronic and computer arts and, more particularly, to machine learning, image processing, data security, and data privacy.

### BRIEF SUMMARY

Principles of the invention provide systems and techniques for large-scale image data encryption and compression using overfitting on a pretrained image model. In one aspect, an exemplary computer-implemented method includes the operations of training a text-to-image machine learning model by using a training dataset, wherein the training dataset comprises images and respective natural language descriptions of those images, wherein the training causes the text-to-image machine learning model to be overfit on the training dataset; storing the trained overfit text-to-image machine learning model; submitting a given natural language description to the stored overfit text-to-image machine learning model; and, in response to the submitting, receiving as output from the overfit text-to-image learning machine learning model an output image, wherein the output image is a reproduction of a corresponding image from the training dataset and corresponds to the submitted natural language description.

Optionally, the method further includes producing the natural language descriptions of the training dataset via inputting the images of the training dataset into an image-to-text machine learning model and, in response, receiving the natural language descriptions as output from the image-to-text machine learning model.

In one aspect, a computer program product comprises one or more tangible computer-readable storage media and program instructions stored on at least one of the one or more tangible computer-readable storage media, the program instructions executable by a processor, the program instructions comprising training a text-to-image machine learning model by using a training dataset, wherein the training dataset comprises images and respective natural language descriptions of those images, wherein the training causes the text-to-image machine learning model to be overfit on the training dataset; storing the trained overfit text-to-image machine learning model; submitting a given natural language description to the stored overfit text-to-image machine learning model; and, in response to the submitting, receiving as output from the overfit text-to-image learning machine learning model an output image, wherein the output image is a reproduction of a corresponding image from the training dataset and corresponds to the submitted natural language description.

In one aspect, a system comprises a memory and at least one processor, coupled to the memory, and operative to perform operations comprising training a text-to-image machine learning model by using a training dataset, wherein the training dataset comprises images and respective natural language descriptions of those images, wherein the training causes the text-to-image machine learning model to be overfit on the training dataset; storing the trained overfit text-to-image machine learning model; submitting a given natural language description to the stored overfit text-to-image machine learning model; and, in response to the submitting, receiving as output from the overfit text-to-image learning machine learning model an output image, wherein the output image is a reproduction of a corresponding image from the training dataset and corresponds to the submitted natural language description.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1A, 1B, and 1C illustrate a number of disadvantages of large-scale image datasets;

FIG. 2 is a workflow for an example large-scale image data encryption and compression system using the overfitting of pretrained image models, in accordance with an example embodiment;

FIG. 3 illustrates the advantages of training an overfitted text-to-image model, in accordance with example embodiments;

FIG. 4 illustrates a workflow for generating a natural language description, in accordance with example embodiments;

FIG. 5 is a workflow for training a visual-linguistic transformer (VL-transformer) as the text-to-image model, in accordance with example embodiments;

FIG. 6 is a workflow for generating a new training dataset, in accordance with example embodiments;

FIG. 7 is a flowchart for an example method for an example large-scale image data encryption and compression method using overfitting on pretrained image models, in accordance with an example embodiment; and

FIG. 8 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

In general terms, an exemplary method, according to an aspect of the invention, includes the operations of training a text-to-image machine learning model 274 by using a training dataset 262, wherein the training dataset 262 comprises images and respective natural language descriptions 254 of those images, wherein the training causes the text-to-image machine learning model 274 to be overfit on the training dataset 262; storing the trained overfit text-to-image machine learning model 274; submitting a given natural language description 254 to the stored overfit text-to-image machine learning model 274; and, in response to the submitting, receiving as output from the overfit text-to-image learning machine learning model 274 an output image, wherein the output image is a reproduction of a corresponding image from the training dataset 262 and corresponds to the submitted natural language description 254.

Corresponding beneficial technical effects include, for example, effectively compressing massive image data with a very low data loss rate, effectively encrypting image data to provide privacy during data distribution and transmission, reduced memory size for compressed image libraries, and/or private, secure data transmission.

In one example embodiment, the natural language descriptions 254 of the training dataset 262 are produced via inputting the images of the training dataset 262 into an image-to-text machine learning model 412 and, in response, the natural language descriptions 254 are received as output from the image-to-text machine learning model 412. Such example embodiments provide the technical effect of improving processing time by using machine learning to generate natural language descriptions 254 for images of the training dataset 262.

In one example embodiment, the natural language descriptions 254 of the training dataset 262 are stored as a text collection 254; the text collection 254 is searched based on a first text input; and, in response to the searching, the given natural language description 254 is retrieved from the text collection 254 for the submitting of the given natural language description 254 to the stored overfit text-to-image machine learning model 274. Such example embodiments provide the technical effect of efficiently locating and decompressing training images.

In one example embodiment, the natural language descriptions 254 of the training dataset 262 are stored as a text collection 254, wherein the natural language descriptions 254 are stored with at least one of a respective image label and respective image metadata. Such example embodiments provide the technical effect of efficiently locating and decompressing training images in the specific case where the images employ metadata.

In one example embodiment, the submitting step is repeated with additional natural language descriptions 254 and the receiving step is correspondingly repeated so that multiple additional images that are reproductions of images from the training dataset 262 are received from the overfit text-to-image machine learning model 274; the multiple additional images are added to the additional natural language descriptions 254, respectively, to produce an additional training dataset; and a second machine learning model is trained using the additional training dataset; and inferencing is performed using the trained second machine learning model. Such example embodiments provide the technical effect of improving the technological process of computerized machine learning such as in the case of deep learning (e.g., for computer vision) by a novel technique that employs compressing/encrypting training data using deliberate overfitting so that training data can be distributed in a more efficient and secure manner—the distributed data can then be used to train the desired model for the desired task and can be deployed and used for inferencing.

In one example embodiment, the overfit text-to-image machine learning model 274 is received at a remote node via a network, wherein the submitting and the receiving steps are performed with the text-to-image machine learning model 274 positioned at the remote node. Such example embodiments provide the technical effect of efficiently transferring the training dataset 262 via the network while consuming fewer network resources.

In one example embodiment, the training the overfit text-to-image machine learning model 274 is performed using sequence-to-sequence training. Such example embodiments provide the technical effect of efficiently transferring the training dataset 262 via the network while consuming less network resources in the case of sequence-to-sequence learning.

In one example embodiment, the natural language descriptions 254 are stored in one or more of a data heap and a data tree. Such example embodiments provide the technical effect of efficiently transferring the training dataset 262 via the network while consuming less network resources in the case of a data heap and a data tree, and efficiently locating images in the training dataset 262.

In one example embodiment, the text-to-image machine learning model 274 comprises a Fast Region-based Convolutional Neural Network that generates appearance features and geometry embeddings for a respective image that is input. Such example embodiments provide the technical effect of efficiently transferring the training dataset 262 via the network while consuming less network resources in the case when the machine learning model 274 comprises a Fast Region-based Convolutional Neural Network.

In one example embodiment, the text-to-image machine learning model 274 produces embeddings selected from the group consisting of token embeddings, visual feature embeddings, segment embeddings, and sequence position embeddings. Such example embodiments provide the technical effect of efficiently transferring the training dataset 262 via the network while consuming less network resources in the case when these specific embeddings are used.

In one aspect, a computer program product comprises one or more tangible computer-readable storage media and program instructions stored on at least one of the one or more tangible computer-readable storage media, the program instructions executable by a processor, the program instructions comprising training a text-to-image machine learning model 274 by using a training dataset 262, wherein the training dataset 262 comprises images and respective natural language descriptions 254 of those images, wherein the training causes the text-to-image machine learning model 274 to be overfit on the training dataset 262; storing the trained overfit text-to-image machine learning model 274; submitting a given natural language description 254 to the stored overfit text-to-image machine learning model 274; and, in response to the submitting, receiving as output from the overfit text-to-image learning machine learning model 274 an output image, wherein the output image is a reproduction of a corresponding image from the training dataset 262 and corresponds to the submitted natural language description 254.

In one aspect, a system comprises a memory and at least one processor, coupled to the memory, and operative to perform operations comprising training a text-to-image machine learning model 274 by using a training dataset 262, wherein the training dataset 262 comprises images and respective natural language descriptions 254 of those images, wherein the training causes the text-to-image machine learning model 274 to be overfit on the training dataset 262; storing the trained overfit text-to-image machine learning model 274; submitting a given natural language description 254 to the stored overfit text-to-image machine learning model 274; and, in response to the submitting, receiving as output from the overfit text-to-image learning machine learning model 274 an output image, wherein the output image is a reproduction of a corresponding image from the training dataset 262 and corresponds to the submitted natural language description 254.

Large-scale image datasets are often used for training machine learning models and typically require the distribution of such datasets over computer networks as well as the exposure of the information within the images to individuals performing the training. The training datasets often include, for example, 40 to 50 Gigabytes (Gb) of information. In general, the transferring or downloading of such datasets is a time-consuming affair. Moreover, some datasets involve sensitive or privacy-related data (such as data related to an individual's face), which are often at risk of exposure during transmission, and may also be seen by the algorithm engineers or data scientists who use the data during training and other tasks. The merging and organizing of datasets is also a very complicated and time-consuming matter in the case, for example, of joint training across different datasets.

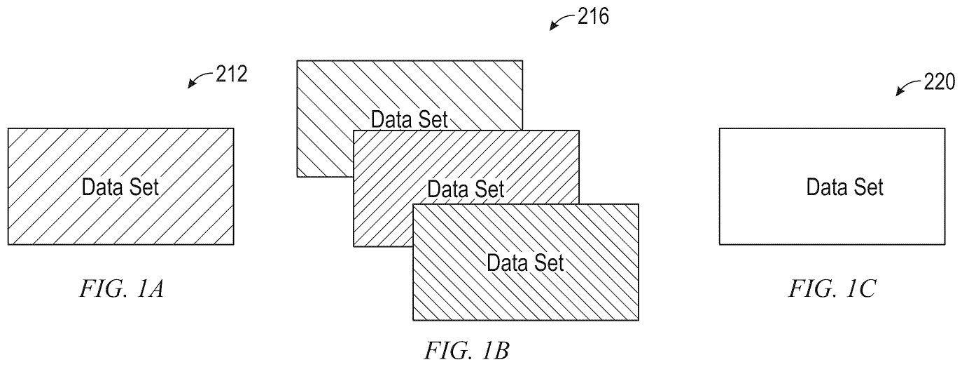

In general, systems and methods are disclosed for providing image data encryption, compression, or both by exploiting the characteristics of the overfitting of pretrained vision models. FIGS. 1A-1C illustrate a number of disadvantages of large-scale image datasets, which can be advantageously addressed by embodiments of the invention. As illustrated in FIG. 1A view 212, large-scale image datasets are often too big to share or transfer quickly. As illustrated in FIG. 1B view 216, the joint training of a plurality of large-scale image datasets is often difficult to manage. As illustrated in FIG. 1C view 220, private information in the large-scale image datasets is at risk of being maliciously accessed, misused or both, even by authorized users.

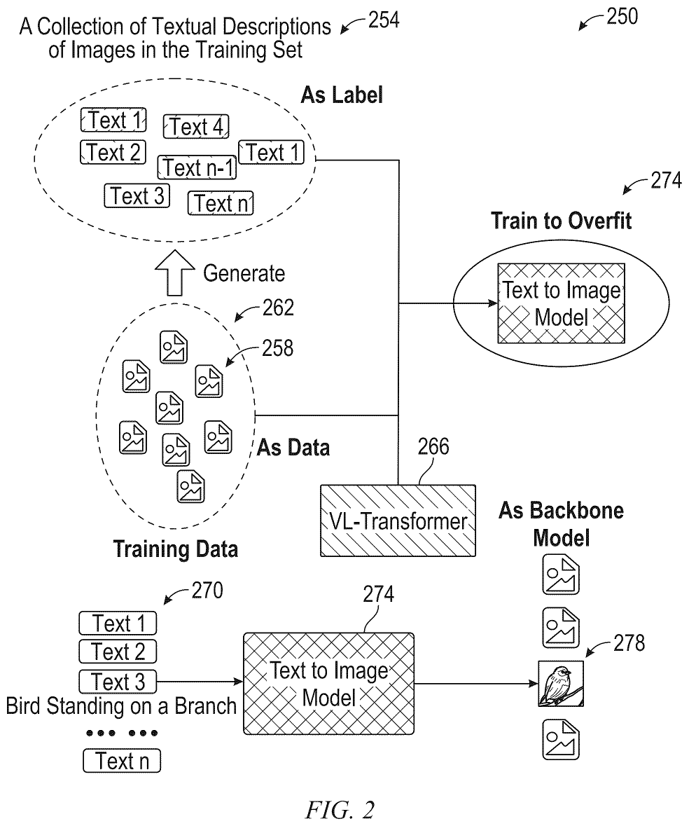

FIG. 2 is a workflow 250 for an example large-scale image data encryption and compression system using the overfitting of pretrained image models, in accordance with an example embodiment. The exemplary system and corresponding exemplary methods are based on pretrained visual models and advantageously employ a novel overfitting phenomenon. Using the exemplary system, a very large image dataset 262 can be compressed to, for example, about one percent of the original dataset 262. (For example, a 100 gigabyte (GB) image dataset can be compressed to about 1 GB.) The image data can be effectively retrieved from the overfit text-to-image model 274 (also referred to as text-to-image model 274 herein) and organized. In addition, the information is well encrypted since it is embedded within the text-to-image model 274. It is noted that, for tasks that utilize compression and are not based on encryption, exemplary embodiments of the image compression and encryption system are most effective for compressing a number of images having an aggregate data size substantially larger than the 100 megabyte (MB) size of a typical text-to-image model 274; however, for tasks based on encryption-only or tasks involving both compression and encryption, the size of the image dataset 262 in relation to the text-to-image model 274 is of less importance.

In one example embodiment, a visual-linguistic transformer (VL-transformer) model 266 (a pre-trained model based on computer vision) is used as the backbone model of the image compression and encryption system and implements the text-to-image model 274. (One non-limiting example of the VL-transformer is a visual-linguistic transformer bidirectional encoder representations from transformers (VL-BERT).) In one example embodiment, sequence-to-sequence training is implemented. After training, a textual description 270 is input into the text-to-image model 274 and the image 278 corresponding to the textual description 270 is produced by the text-to-image model 274.

During training, the images 258 that are to be encrypted/compressed are taken as a training dataset 262 for the text-to-image model 274. For each image 258 in the training dataset 262, the label and the metadata of the image 258 are used to automatically generate a natural language description 254 for each image 258. For example, the label and the metadata may be concatenated together as the natural language description 254. The original image 258 and the corresponding natural language description 254 are then used as the training data for training the text-to-image model 274. In one example embodiment, the image 258 is processed by an image-to-text task and the corresponding description is used as the natural language description 254 for training the text-to-image model 274, or is used in conjunction with the label and the metadata of the image 258 as the natural language description 254 for training the text-to-image model 274.

It is noted that the text-to-image model 274 is typically required to be trained to a sufficient degree of overfitting such that, when the natural language description 254 corresponding to a certain image 258 (such as an Image-A) is input into the trained text-to-image model 274, the text-to-image model 274 will restore “Image-A” very accurately (that is, there is a one-to-one correspondence between the natural language description 254 and the image 258). In one example embodiment, a portion of the training dataset 262 is used as validation data and a portion of the training dataset 262 is used as testing data. The validation data and the testing data are then processed by the text-to-image model 274 to ensure that the text-to-image model 274 is sufficiently overfit to generate a one-to-one correspondence between model input and output and to faithfully reproduce the appropriate image 258. Then, after such training, each image 258 in the training dataset 262 is encoded in the trained text-to-image model 274, and the textual description of the image 258 may be used to retrieve the image 258 from the text-to-image model 274. The so-trained text-to-image model 274 is often only 1% the size of the original training dataset 262. This size reduction represents an improvement due to less computer memory space needed for storage and fewer resources to distribute the training dataset via, for example, a network.

In one example embodiment, the natural language descriptions 254 are stored in heaps or trees, and can be efficiently searched to identify training data 262 when needed for training across datasets 262. In addition, since the image data 262 is encoded in the text-to-image model 274, the system also has a very good encryption effect.

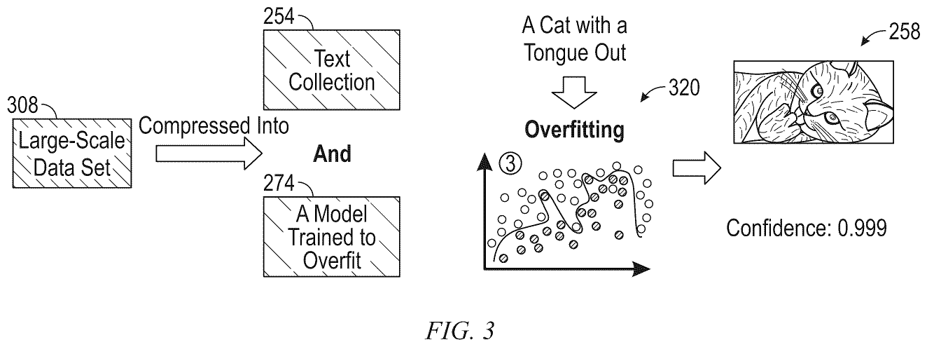

FIG. 3 illustrates exemplary advantages of training an overfitted text-to-image model 274, in accordance with example embodiments. Consider why the text-to-image model 274 should be trained to overfit; and what the benefit of doing this is. Distribution 320 of FIG. 3 represents an overfitting phenomenon where the bounds in the legend show how well the model fits, which is a typical phenomenon of overfitting. In the training of deep learning models, the overfitting phenomenon has the following properties:
the models trained to overfit are more “hard-coded” or exhibit a “one-to-one correspondence” between input and output;
the accuracy rate on the training set is often more than 99% (or even higher); and
it will not perform well in the face of new data (similar to an overfitted polynomial curve fit, it matches the training data points closely (which allows the accurate reproduction of the large input data set) but does not accurately match the underlying physical phenomenon and does not yield accurate predictions on test data).

These properties are advantageous for the present tasks of compression and encryption. As a result of the “one-to-one correspondence” between input and output, after training the text-to-image model 274 on a large-scale dataset 308 to overfit, a fixed (specific) input can be provided to the text-to-image model 274 and a corresponding image 258 (the original image 258 provided in training that corresponds to the specific input) is produced by the text-to-image model 274. The large-scale dataset 308 initially includes multiple images. The trained text-to-image model 274 represents a novel way to store the images of the large-scale dataset 308 in a compressed form so that less computer memory is required for the storage. (It is noted that overfitting of the text-to-image model 274 occurs, for example, when training of the text-to-image model 274 continues for an extended period of time. For example, a pertinent indicator to measure sufficient overfitting is that the accuracy of the model on the training set is, for example, 100% and the accuracy of the model on the test set is 0%.) Then, it is only needed to store the natural language description 254 and the text-to-image model 274 trained to overfit, which is equivalent to storing all the images 258 in the training set 254 in an amount of storage equal to that of the text-to-image model 274. The size of the text and the text-to-image model 274 itself is often only one percent of the original training set 254. The present embodiments achieve efficient compression of very large datasets 254. This dataset 254 will be compressed into a collection of natural language descriptions 254 and the text-to-image model 274. The compression of the dataset 254 into the text-to-image model 274 also in some embodiments is able to achieve encryption of the dataset 254.

In some embodiments, the trained model is classified as overfitted based on the model accuracy values or on a combination of model accuracy values. In some embodiments, the trained model is classified as overfitted based on the model accuracy prediction value having accuracy greater than or equal to 70%, 80%, 85%, 90%, 95%, or 99% to perform accurate image generation on the training data set. In some embodiments, the trained model is classified as overfitted based on:
(1) the model accuracy prediction value having first accuracy greater than or equal to 70%, 80%, 85%, 90%, 95%, 99%, or 100% of performing accurate image generation on the training data set,
(2) the model accuracy prediction value having a second accuracy of less than or equal to 30%, 20%, 15%, 10%, 5%, 1%, or 0%, where the second accuracy is produced from the trained model being asked to generate images for data that was not part of the training dataset, e.g., is part of a test dataset,
(3) a combination of the (1) and (2) factors described above, or
(4) the model accuracy prediction value having a second accuracy of less than half or more of the various possible first accuracy values/ranges mentioned above, where the second accuracy is produced from the trained model being asked to generate images for data that was not part of the training dataset, e.g., is part of a test dataset.

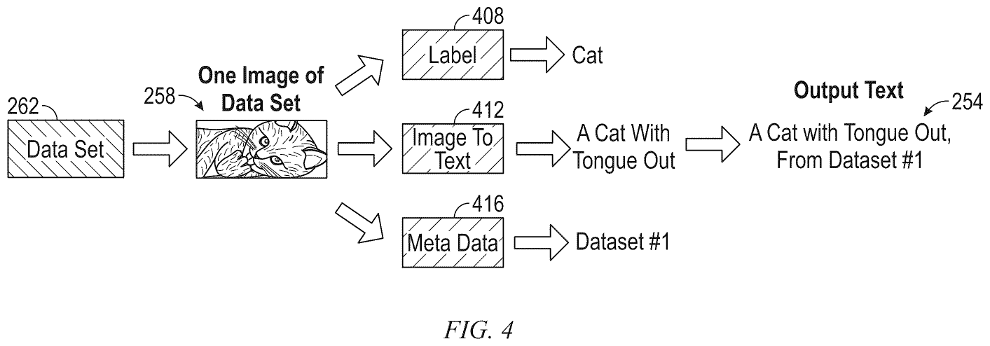

FIG. 4 illustrates a workflow for generating a natural language description 254, in accordance with example embodiments. Consider how to generate a corresponding natural language description 254 for each image 258 in the training set 262, and how these natural language descriptions 254 should be generated. Consider further why it is appropriate to generate semantic textual descriptions instead of using a fixed and unique encoding, e.g., instead of using a universally unique identifier (UUID).

For the subtask of text description generation, the image-to-text algorithm 412 generates the natural language description 254 based on the image 258. In example embodiments, the image-to-text algorithm 412 also uses the label 408 corresponding to the image 258, the metadata 416 of the image 258 (such as which dataset 262 the image 258 comes from), or both, to generate the natural language description 254. It is noted that the generated natural language description 254 does not need to have a very smooth grammar, or even a combination of several words. It only needs to roughly indicate the meaning of the image semantically. Therefore, the natural language description 254 corresponding to the image 258 does not need to be overly complicated, but should just uniquely and semantically identify the corresponding image 258. The image-to-text algorithm 412 is a machine learning algorithm which is able to use computer vision to recognize semantically the contents of an image, produce text such as a caption that provides and/or describes the semantic meaning of the contents, and produce that text as an output. In some embodiments, this text produced is a caption and/or the name of a classification group of the image to which the image belongs (as determined by the image-to-text algorithm).

A reason or advantage of introducing “descriptive text” in this step is to use semantic information to efficiently and flexibly retrieve similar images 258 that are, for example, originally in different datasets 254 before the image information is encoded into the text-to-image model 274. For example, there are images 258 of the cat category in two different conventional vision datasets. Images 258 from both datasets 254 are encoded into a text-to-image model 274. Then, the keyword, such as “cat,” can be used to search for the natural language descriptions 254 in the text description set that correspond to the category of “cat.” These natural language descriptions 254 can be used to retrieve the corresponding images 258 by inputting the natural language descriptions 254 into the overfit text-to-image model 274 that encodes the images 258, and using the overfitting property of the text-to-image model 274 to restore the original image(s) 258. The restored images 258 can be from one dataset 262 or from multiple datasets 262. By selecting a particular input text to submit the to the trained text-to-image model 274, the choice of which of the stored images to reproduce is controlled.

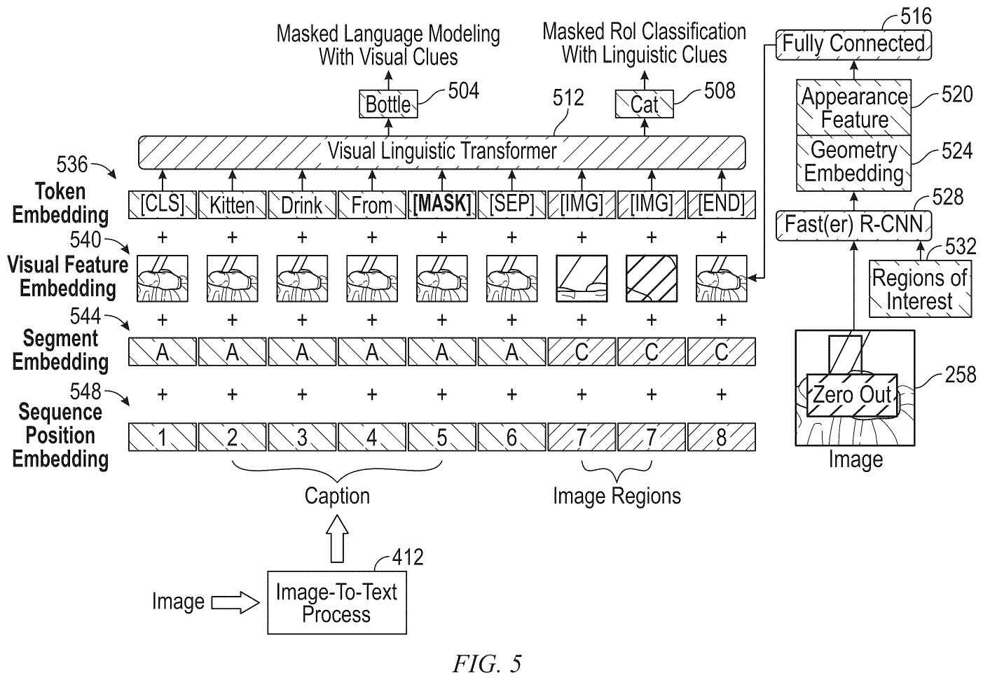

FIG. 5 is a workflow for training a VL-transformer 512 as the text-to-image model 274 (as illustrated in FIGS. 2 and 3), in accordance with example embodiments. The structure of the trained text-to-image model 274, which is essentially a transformer-based, pre-trainable general representation for language-vision tasks, is also shown in FIG. 5. It is noted that VL-transformer 512 is an example model type and other model types are contemplated. As described above, for the subtask of text description generation, the image-to-text algorithm 412 generates the natural language description 254 based on the image 258 and the natural language description 254 is used in the training of the VL-transformer 512.

In one example embodiment, a text-to-image task is used to train the text-to-image model 274 of the VL-transformer 512 to the point of overfitting. In one example embodiment, a Fast(er) Region-based Convolutional Neural Network (R-CNN) (with attention mechanism) 528 processes the image 258 to generate appearance features 520 of the image 258 and to generate geometry embeddings 524 for the image 258. In one example embodiment, the R-CNN 528 also receives an identification of the regions of interest 532 of the image 258 determined by the object detection process using known techniques, as will be apparent to the skilled person given the teachings herein.

A fully connected embedding transformer 516 unifies the data and converts the appearance features 520 and the geometry embedding 524 from, for example, 100 dimensions to higher-dimension embeddings of, for example, 300 or 500 dimensions, without changing the meaning of the data. The higher-dimension embeddings include token embeddings (encoding of words as embeddings) 536, visual feature embeddings 540 (such as color, domain, lines/circles/edges, and the like), segment embeddings 544 (such as a cat or dog segment), and sequence position embeddings 548 (representing positions of the segments). The attention mechanism mentioned above processes the image 258 to enhance the filters of the VL-transformer 512 based on the regions of interest 532 of the image 258.

The masked language modeling with visual clues 504 and masked region of interest (RoI) classification with linguistic clues 508 are pre-training tasks initially used to pre-train the text-to-image model 274 in the VL-transformer 512. For example, FIG. 5 shows the word “bottle” in element 504. For the masked language modeling with visual clues 504, without the full image a portion of the image caption is masked (e.g., a cat drinking from [MASK]) (e.g., bottle, cup, bowl, etc.) and submitted with the regions of interest 532 to train the model to learn the masked word and generate the full image. For the masked RoI classification with linguistic clues 508, a linguistic clue such as “cat” or “cat drinking from bottle” is input while the image is input with the regions of interest 532 masked out and the model is trained to predict the image category from those inputs. For pre-training that includes the words received from image-to-text process 412, one or more of those words can be involved in the pre-training tasks 504, 508. The skilled artisan will have general familiarity with VL-transformer, matrix calculation for compression processes (e.g., in fully connected layers), matrix operations associated with transformers, and the like; given the teachings herein, the skilled artisan can adapt known techniques to implement one or more embodiments.

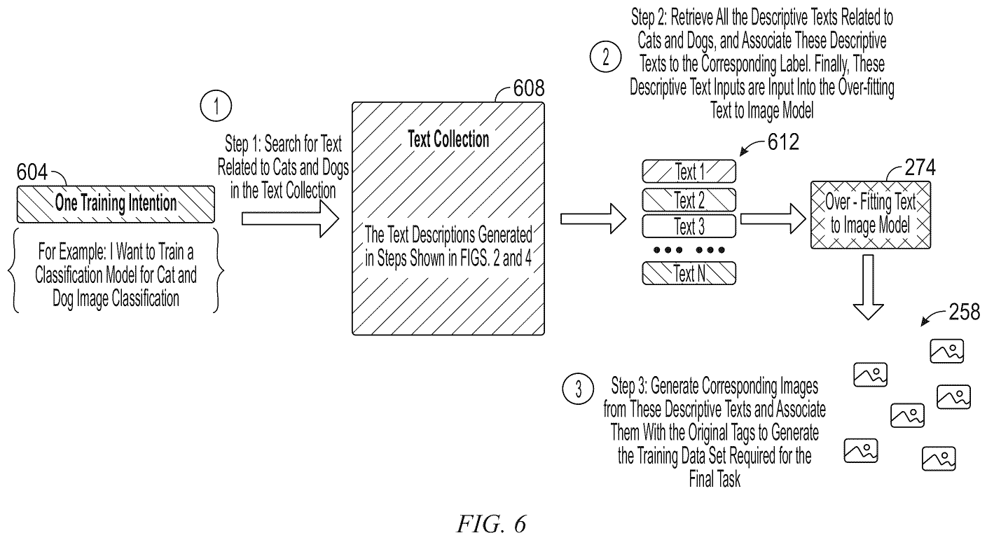

FIG. 6 is a workflow for generating a new training dataset, in accordance with example embodiments. In one example embodiment, one training intention 604, such as training a classification model for cat and dog classification, is submitted and used to search for text related to cats and dogs in a text collection 254 (step 1). The text collection 254 may be, for example, a collection of the natural language descriptions 254. In this example, the very large image dataset 262 that was used to initially train the text-to-image model 274 included images of cats and dogs as well as other images. The descriptive texts 612 related to cats and/or dogs are retrieved from the text collection 254 (step 2). In one example embodiment, the retrieved descriptive texts 612 are associated in the text collection 254 with a corresponding label 408, corresponding metadata 416, or both. The retrieved descriptive text 612 along with the image 258 and optionally any associated label 408 and/or metadata 416 are input into the trained text-to-image model 274 (step 2).

The step (1) in some embodiments includes semantic similarity ML search to match the semantic meaning of the training intention 604 with the various information stored in the text collection 254. Thus, by using semantic similarity ML search an exact match of words of the intention 604 to the previously stored text of the text collection 254 is not required. In other embodiments, raw word matching, e.g., with word stemming, is performed via the program 200 in order to find a letter-to-letter match of the words of the training intention 604 to the word contents of the text collection 254.

The inputting of the cat and dog text descriptors into the trained text-to-image model 274 in step (2) causes the trained text-to-image model to generate the image 258 corresponding to the submitted natural language description 254 (step 3) (e.g., the “stored” images of the cats and dogs from the very large image dataset 262. The generated image(s) 258 is/are then provided as a component of a new training dataset, a decompressed image library, or both. The generated images 258 along with the retrieved descriptive texts 612 together then constitute a new training dataset which can be used to perform a final task such as training another text-to-image model to efficiently “store” the images of cats and dogs without the remaining (non-cat and non-dog) images of the very large image dataset 262. This new text-to-image model is smaller (e.g., include fewer layers and/or parameters) than the initial trained (first) text-to-image model 274 and takes up less computer memory storage space than the initial trained text-to-image model 274 takes up.

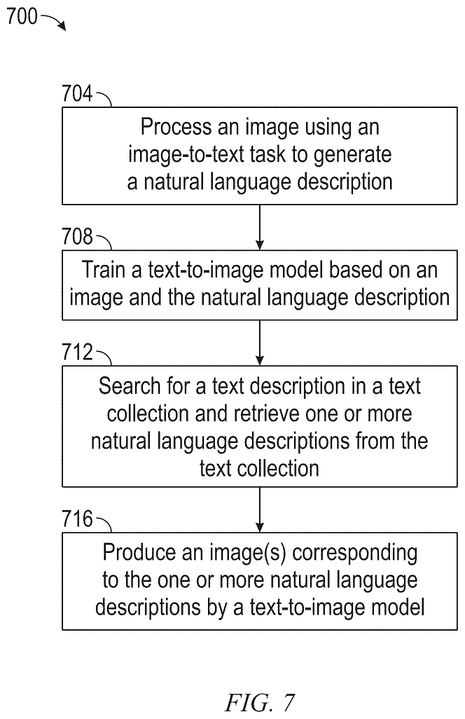

FIG. 7 is a flowchart for an example method 700 for an example large-scale image data encryption and compression method using overfitting on pretrained image models, in accordance with an example embodiment. In one example embodiment, each image 258 of an image dataset 262 to be compressed/encrypted is processed by a conventional image-to-text task (implemented, e.g., with a suitably trained machine learning model as would be appreciated by the skilled artisan given the teachings herein) to generate a natural language description 254 of the image 258 (operation 704). A text-to-image model 274 is trained based on images 258 of the image dataset 262 and the natural language description 254 to the point of being overfit (operation 708). In one example embodiment, the natural language description 254 utilized in operation 708 is based on the natural language description 254 generated in operation 704, a label 408 of the image 258, metadata 416 of the image 258, or any combination thereof. By way of clarification, the NLD 254 utilized when training the model 274 can be an NLD automatically generated by the image-to-text task in operation 704. Alternatively, a label of the image can be used as the NLD, metadata of the image can be used as the NLD, or any combination of all these elements can be used. A text description 604 is searched for in a text collection 254 and one or more corresponding natural language descriptions 254 are retrieved from the text collection 254 (operation 712). For example, a text description 604 of “dog” is submitted and a set of natural language descriptions 254 related to the category of “dog” are retrieved. One or more of the retrieved natural language descriptions 254 of the set are input to the text-to-image model 274 and the image(s) 258 corresponding to the input natural language description(s) 254 is produced by the text-to-image model 274 (operation 716).

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
systems and techniques for effectively compressing massive image data with a very low data loss rate;
systems and techniques for effectively encrypting image data to provide privacy during data distribution and transmission;
reduced memory size for compressed image libraries;
private, secure data transmission;
overfitting model methods for compressing data where the compressed data supports natural language retrieval and supports joint training across data sets;
improve the technological process of computerized machine learning such as in the case of deep learning (e.g., for computer vision) by a novel technique that employs compressing/encrypting training data using deliberate overfitting so that training data can be distributed in a more efficient and secure manner—the distributed data can then be used to train the desired model for the desired task and can be deployed and used for inferencing.

An exemplary method, according to an aspect of the invention, includes the operations of processing each image 258 of an image dataset 262 to generate a corresponding natural language description 254 (operation 704); training an overfit text-to-image model 274 based on each image 258 of the image dataset 262 and the corresponding natural language description 254 (operation 708); storing the trained text-to-image model 274; submitting a given natural language description 254 to the stored text-to-image model 274; and reproducing, using the stored text-to-image model 274, an image 258 of the image dataset corresponding to the submitted natural language description 254 (operation 716).

In one example embodiment, a text collection 254 is searched for a text description 604 and one or more corresponding natural language descriptions 254 are retrieved from the text collection 254 for submission to the stored text-to-image model 274 (operation 712).

In one example embodiment, the natural language description 254 utilized in the searching operation 708 is based on one or more of: the natural language description 254 generated in the processing operation 704, a label of the image 258, and metadata of the image 258.

In one example embodiment, the reproducing the image 258 operation is repeated for a plurality of the natural language descriptions 254 to reproduce the image dataset 262 (operation 716); a machine learning model is trained using the reproduced dataset 262; and inferencing is performed using the trained machine learning model.

In one example embodiment, the overfit text-to-image model is received at a remote node via a network and the reproducing of the image, the training the machine learning model, and the performing inferencing are performed by the remote node.

In one example embodiment, the overfit text-to-image model 274 is implemented using a visual-linguistic bidirectional encoder representations from transformers model 266.

In one example embodiment, the training the overfit text-to-image model 274 is performed using sequence-to-sequence training.

In one example embodiment, the given natural language description 254 is stored in one or more of a heap and a tree to enable efficient searching for training data 262.

In one example embodiment, the processing each image 258 uses a Fast Region-based Convolutional Neural Network 528 to generate appearance features 520 of the image 258 and to generate geometry embeddings 524 for the image 258.

In one example embodiment, the geometry embeddings include one or more of token embeddings 536, visual feature embeddings 540, segment embeddings 544, and sequence position embeddings 548.

In one aspect, a computer program product comprises one or more tangible computer-readable storage media and program instructions stored on at least one of the one or more tangible computer-readable storage media, the program instructions executable by a processor, the program instructions comprising processing each image 258 of an image dataset 262 to generate a corresponding natural language description 254 (operation 704); training an overfit text-to-image model 274 based on each image 258 of the image dataset 262 and the corresponding natural language description 254 (operation 708); storing the trained text-to-image model 274; submitting a given natural language description 254 to the stored text-to-image model 274; and reproducing, using the stored text-to-image model 274, an image 258 of the image dataset corresponding to the submitted natural language description 254 (operation 716).

In one aspect, a system comprises a memory and at least one processor, coupled to the memory, and operative to perform operations comprising processing each image 258 of an image dataset 262 to generate a corresponding natural language description 254 (operation 704); training an overfit text-to-image model 274 based on each image 258 of the image dataset 262 and the corresponding natural language description 254 (operation 708); storing the trained text-to-image model 274; submitting a given natural language description 254 to the stored text-to-image model 274; and reproducing, using the stored text-to-image model 274, an image 258 of the image dataset corresponding to the submitted natural language description 254 (operation 716).

Example embodiments provide data compression using overfitting techniques and data encryption with large models, where the compressed data has the ability to be indexed by natural language. In one example embodiment, as opposed to using machine learning technology to compress images, the image data is compressed into the parameters of the model.

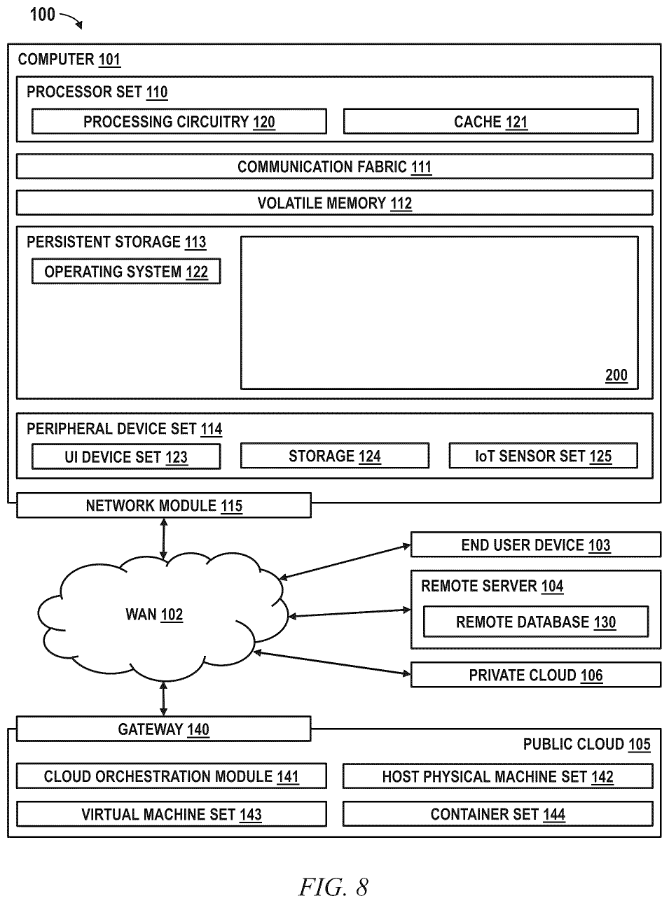

Reference should now be had to FIG. 8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as an image compression and decryption system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
training a text-to-image machine learning model by using a training dataset, wherein the training dataset comprises images and respective natural language descriptions of those images, wherein the training causes the text-to-image machine learning model to be overfit on the training dataset;
storing the trained overfit text-to-image machine learning model;
submitting a given natural language description to the stored overfit text-to-image machine learning model; and
in response to the submitting, receiving as output from the overfit text-to-image learning machine learning model an output image, wherein the output image is a reproduction of a corresponding image from the training dataset and corresponds to the submitted natural language description.

2. The computer-implemented method of claim 1, further comprising producing the natural language descriptions of the training dataset via inputting the images of the training dataset into an image-to-text machine learning model and, in response, receiving the natural language descriptions as output from the image-to-text machine learning model.

3. The computer-implemented method of claim 1, further comprising:
storing the natural language descriptions of the training dataset as a text collection;
searching the text collection based on a first text input; and
in response to the searching, retrieving the given natural language description from the text collection for the submitting of the given natural language description to the stored overfit text-to-image machine learning model.

4. The computer-implemented method of claim 1, further comprising storing the natural language descriptions of the training dataset as a text collection, wherein the natural language descriptions are stored with at least one of a respective image label and respective image metadata.

5. The computer-implemented method of claim 1, further comprising:
repeating the submitting step with additional natural language descriptions and correspondingly repeating the receiving step so that multiple additional images that are reproductions of images from the training dataset are received from the overfit text-to-image machine learning model;
adding the multiple additional images to the additional natural language descriptions, respectively, to produce an additional training dataset; and
training a second machine learning model using the additional training dataset; and
performing inferencing using the trained second machine learning model.

6. The computer-implemented method of claim 1, further comprising:
receiving the overfit text-to-image machine learning model at a remote node via a network, wherein the submitting and the receiving steps are performed with the text-to-image machine learning model positioned at the remote node.

7. The computer-implemented method of claim 1, wherein the training the overfit text-to-image machine learning model is performed using sequence-to-sequence training.

8. The computer-implemented method of claim 1, further comprising storing the natural language descriptions in one or more of a data heap and a data tree.

9. The computer-implemented method of claim 1, wherein the text-to-image machine learning model comprises a Fast Region-based Convolutional Neural Network that generates appearance features and geometry embeddings for a respective image that is input.

10. The computer-implemented method of claim 1, wherein the text-to-image machine learning model produces embeddings selected from the group consisting of token embeddings, visual feature embeddings, segment embeddings, and sequence position embeddings.

11. A computer program product, comprising:
one or more tangible computer-readable storage media and program instructions stored on at least one of the one or more tangible computer-readable storage media, the program instructions executable by a processor to cause the processor to perform operations comprising:
training a text-to-image machine learning model by using a training dataset, wherein the training dataset comprises images and respective natural language descriptions of those images, wherein the training causes the text-to-image machine learning model to be overfit on the training dataset;
storing the trained overfit text-to-image machine learning model;
submitting a given natural language description to the stored overfit text-to-image machine learning model; and
in response to the submitting, receiving as output from the overfit text-to-image learning machine learning model an output image, wherein the output image is a reproduction of a corresponding image from the training dataset and corresponds to the submitted natural language description.

12. A system comprising:
a memory; and
at least one processor, coupled to said memory, and operative to perform operations comprising:
training a text-to-image machine learning model by using a training dataset, wherein the training dataset comprises images and respective natural language descriptions of those images, wherein the training causes the text-to-image machine learning model to be overfit on the training dataset;
storing the trained overfit text-to-image machine learning model;
submitting a given natural language description to the stored overfit text-to-image machine learning model; and
in response to the submitting, receiving as output from the overfit text-to-image learning machine learning model an output image, wherein the output image is a reproduction of a corresponding image from the training dataset and corresponds to the submitted natural language description.

13. The system of claim 12, the operations further comprising producing the natural language descriptions of the training dataset via inputting the images of the training dataset into an image-to-text machine learning model and, in response, receiving the natural language descriptions as output from the image-to-text machine learning model.

14. The system of claim 12, the operations further comprising:
storing the natural language descriptions of the training dataset as a text collection;
searching the text collection based on a first text input; and
in response to the searching, retrieving the given natural language description from the text collection for the submitting of the given natural language description to the stored overfit text-to-image machine learning model.

15. The system of claim 12, the operations further comprising storing the natural language descriptions of the training dataset as a text collection, wherein the natural language descriptions are stored with at least one of a respective image label and respective image metadata.

16. The system of claim 12, the operations further comprising:
repeating the submitting step with additional natural language descriptions and correspondingly repeating the receiving step so that multiple additional images that are reproductions of images from the training dataset are received from the overfit text-to-image machine learning model;
adding the multiple additional images to the additional natural language descriptions, respectively, to produce an additional training dataset; and
training a second machine learning model using the additional training dataset; and
performing inferencing using the trained second machine learning model.

17. The system of claim 12, the operations further comprising:
receiving the overfit text-to-image machine learning model at a remote node via a network, wherein the submitting and the receiving steps are performed with the text-to-image machine learning model positioned at the remote node.

18. The system of claim 12, wherein the training the overfit text-to-image machine learning model is performed using sequence-to-sequence training.

19. The system of claim 12, the operations further comprising storing the natural language descriptions in one or more of a data heap and a data tree.

20. The system of claim 12, wherein the text-to-image machine learning model comprises a Fast Region-based Convolutional Neural Network that generates appearance features and geometry embeddings for a respective image that is input.
